(19) United States
(12) Patent Application Publication
(10) Pub. No.: US 2011/0089642 A1
(43) Pub. Date: Apr. 21, 2011

(54) Bearing Seal

(75) Inventor: Hiroshi Terasawa, Okayama (JP)

(73) Assignee: Uchiyama Manufacturing Corp., Okayama (JP)

(21) Appl. No.: 12/999,510

(22) PCT Filed: Jun. 1, 2009
(86) PCT No.: PCT/JP2009/059966

§ 371 Date: Dec. 16, 2010

(30) Foreign Application Priority Data
Jun. 25, 2008 (JP) 2008-165264

(51) Int. Cl. F16J 15/32

(52) U.S. Cl. 277/562

(57) ABSTRACT

A bearing seal of pack seal type used for a bearing unit rotatably supporting a rotary side member on an inner ring side relative to a stationary side member on an outer ring side. The bearing seal comprising a first slinger member having a cylindrical part fitted onto the rotary side member and an outward flange part extended from one end of the cylindrical part of the first slinger member, a second slinger member having a cylindrical part fitted onto the cylindrical part of the first slinger member and an outward flange part extended from one end of the cylindrical part of the second slinger member, a core member having a cylindrical part fitted into the stationary side member and an inward flange part extended from one end of the cylindrical part of the core member, a stationary side seal lip member fixed to the core member and having a seal lip contacting elastically and slidably with the second slinger member, a rotary side seal lip member fixed to the second slinger member and having a seal lip contacting elastically and slidably with the core member, and an annular multipolar magnet attached to the outward flange part of the first slinger member.

### TECHNICAL FIELD

The present invention relates to a bearing seal of pack seal type which seals the bearing unit of automobile wheels and has a magnetic encoder for detecting the rotation number of the rotary side member like wheels.

### BACKGROUND ART

Automobile wheels are rotatably supported via a bearing unit comprised of a rolling body interposed between an inner ring and an outer ring. The bearing unit space including the rolling body is tightly sealed with a bearing seal interposed between the outer ring and the inner ring and lubricant filled in the bearing unit is prevented from leaking and dirt and mud are prevented from entering from outside. Generally used as such a bearing seal is a so-called pack seal type bearing seal in which a slinger fitted to be integrated with a rotary side member (either of the inner ring and the outer ring) and a seal lip member having a seal lip fitted to be integrated with the stationary side member (either of the inner ring and the outer ring) and contacting elastically and slidably with the slinger are combined.

The rotation number of wheels has been recently detected in order to control an antilock brake system (ABS) and a traction control system (TCS) of automobile wheels. The automobile supporting the wheels with the bearing unit using the above-mentioned bearing seal of pack seal type applies a rotation number detection unit in which an annular multipolar magnet (magnetic encoder) magnetized by being provided with a plurality of N poles and S poles alternately in the circumferential direction at an equal pitch on the outside surface of the slinger is provided, a magnetic sensor is provided for the stationary side (automobile body side) so as to face the magnetic encoder, and the rotation number of the wheels is detected by the magnetic change accompanied with the rotation. (refer to the Patent Literatures 1 and 2.)

The bearing seal of the Patent Literatures 1 and 2 has a seal lip member on the rotary side and the seal lip is designed to elastically and slidably contact with a core member fitted and fixed on the stationary side. Specifically in case of the bearing seal of the Patent Literature 2, the inner ring is on rotary side, so that the rotary side seal lip attached to the slinger (attachment ring on rotary side) generates scattering action by the centrifugal force, thereby achieving superior sealing ability. Therefore, a slinger has been recently provided with a seal lip member in case of a bearing seal of pack seal type for the bearing seal wherein the inner ring rotates.

### CITATION LIST

### Patent Literature

PTL 1: JP-A-9-257044
PTL 2: JP-A-2005-337345

### SUMMARY OF INVENTION

### Technical Problem

In case of the bearing seal of the Patent Literature 2, a slinger is provided with a rotary side seal lip made of a rubber elastic material and a pulsar ring (corresponding to a magnetic encoder or a tone wheel) made of a rubber elastic material or a synthetic resin material mixed with magnetic powder. When the rotary side seal lip and the pulsar ring are integrally provided with the slinger, an unvulcanized material forming the seal lip and a unvulcanized material including magnetic powder forming the pulsar ring are partially mixed in a forming procedure and the rotation detection accuracy of the pulsar ring may be affected. Therefore, in the Patent Literature 2, the pulsar ring and the rotary side seal lip are separately formed. However, the forming portion and the formed width of the pulsar ring and the rotary side seal lip are limited in connection with the shape and function of the mold when they are separately produced. In particular, the width of the pulsar ring becomes small and its positioning with the facing magnetic sensor becomes difficult.

According to the structure of the bearing seal of the Patent Literature 1, the outer ring is on rotary side, a core metal on the outer diameter side having the seal lip and a support ring having a tone wheel (corresponding to a magnetic encoder or a pulsar ring) are fitted with each other, the core metal on the inner diameter side is fitted to the inner diameter surface of the outer ring on the rotary side, and the seal lip elastically and slidably contacts with the core metal on the inner diameter side on the stationary side. In this case, the member supporting the rotary side seal lip and the member supporting the tone wheel are separate members, so that the above-mentioned forming limitations do not exist and the forming width of the tone wheel may be largely secured. However, the elastic sliding force of the seal lip relative to the core metal on the inner diameter side may be weakened by the centrifugal force of rotation and the sealing ability may be deteriorated because the outer ring is on rotary side.

The present invention is proposed in view of the above-mentioned problems and has an object to provide a bearing seal of pack seal type having a magnetic encoder for rotating an inner ring which can largely secure the attaching and forming width of the magnetic encoder.

### Solution to Problem

According to the present invention, a bearing seal of pack seal type used for a bearing unit rotatably supporting a rotary side member on an inner ring side relative to a stationary side member on an outer ring side comprises a first slinger member having a cylindrical part fitted onto the rotary side member and an outward flange part extended from one end of the cylindrical part of the first slinger member; a second slinger member having a cylindrical part fitted onto the cylindrical part of the first slinger member and an outward flange part extended from one end of the cylindrical part of the second slinger member; a core member having a cylindrical part fitted into the stationary side member and an inward flange part extended from one end of the cylindrical part of the core member; a stationary side seal lip member fixed to the core member and having a seal lip contacting elastically and slidably to the second slinger member; a rotary side seal lip member fixed to the second slinger member and having a seal lip contacting elastically and slidably to the core member; and an annular multipolar magnet attached to the outward flange part of the first slinger member.

The annular multipolar magnet exerts the function of the magnetic encoder constituting a rotary detection apparatus in combination with the stationary side magnetic sensor. It includes a magnet formed in annular and made of rubber or resin including magnetic powder or an annular sintered magnet in which a plurality of N poles and S poles are alternately provided at regular pitch along the circumferential direction. It is attached with adhesive on the surface opposite to the bearing part of the outward flange part of the first slinger (surface opposite to the cylindrical part) or the surface of the bearing part side (surface on the cylindrical part side).

The outward flange part of the second slinger member and the outward flange part of the first slinger member come into contact to each other when the first slinger member and the second slinger member are combined. Therefore, a gap is formed between an outer circumferential part of the outward flange part of the second slinger member and the outward flange part of the first slinger member. The rotary side seal lip member is fixed to the outer circumferential part of the outward flange part of the second slinger member so as to hold the outer circumferential part.

In this case, the outer circumferential part of the outward flange part of the second slinger member is bent into an extended direction of the cylindrical part of the second slinger member, namely apart from the outward flange part of the first slinger member, so as to constitute a bent part and the gap is formed by the bent part. On the other hand, the outer circumferential part of the outward flange part of the second slinger member is pressed into the cylindrical part of the second slinger member so as to constitute a pressed thin part and the gap is formed by the thin part.

According to the present invention, the second slinger member further has an outer cylindrical part extended from the outer circumferential part of the outward flange part so as to form a U-shaped section and a part of the seal lip of the stationary side seal lip member elastically and slidably contacts an inner diameter part of the outer cylindrical part.

In this case, the rotary side seal lip member has an annular projecting part elastically deformed by the outward flange part of the first slinger member and contacting under pressure when the first slinger member and the second slinger member are combined.

Furthermore according to the present invention, the first slinger member is made of a non-magnetic material, the annular multipolar magnet is provided on a surface of the cylindrical part side of the outward flange part of the first slinger member, and the magnet is further interposed between the outward flange part of the first slinger member and the outward flange part of the second slinger member when the first slinger member and the second slinger member are combined.

### ADVANTAGEOUS EFFECTS OF INVENTION

In case of the bearing seal of the present invention, the seal lip of the stationary side seal lip member fixed to the core member fitted in the stationary side member on the outer ring side elastically and slidably contacts with the second slinger member, and the seal lip of the rotary side seal lip member fixed to the second slinger member elastically and slidably contacts with the stationary side core member, so that the sealing function of the bearing unit can be kept by the elastically slidable contact of these seal lips. In particular, scattering action is caused on the rotary side seal lip by the centrifugal force accompanied with rotation of the inner ring and dust and dirt are effectively prevented from entering the bearing unit. Furthermore, the elastically slidable force of the rotary side seal lip to the stationary side core member becomes strong by the centrifugal force, thereby further improving the sealing function. The outward flange part of the first slinger member is attached with an annular multipolar magnet, and the rotary side seal lip member is designed to be fixed to the second slinger member, so that when the annular multipolar magnet is attached to the first slinger member by molding, the limitation by the rotary side seal lip member is not received, the width size of the outward flange part of the first slinger member can be effectively used as an attachment space of the annular multipolar magnet, and the formed width of the annular multipolar magnet can be largely obtained. Therefore, the magnetic force of the annular multipolar magnet can be adequately developed, and when the annular multipolar magnet is formed as a magnetic encoder and the magnetic sensor is provided so as to face the encoder to constitute a rotation detection unit, each positioning of the magnetic encoder and the magnetic sensor can be facilitated and the design flexibility of the rotation detection unit can be enlarged.

In the present invention, when the first slinger member and the second slinger member are fitted and the outward flange part of the second slinger member and the outward flange part of the first slinger member come into contact to each other, the rigidity of the slinger function parts is enhanced by the first and second slinger members. In this case, when a gap is formed between the outer circumferential part of the outward flange part of the second slinger member and the outward flange part of the first slinger member and the rotary side seal lip member is fixed so as to hold the outer circumferential part relative to the outward flange part of the second slinger member, a part of the rotary side seal lip member actually enters around the gap, and the rotary side seal lip member is firmly fixed to the second slinger member, thereby keeping stable sealing ability also by the rotary centrifugal force. When the gap is formed with the bent part in which the outer circumferential part of the outward flange part of the second slinger member is bent or is formed with a thin part in which the outer circumferential part of the outward flange part of the second slinger member is pressed, the gap can be easily obtained. In addition such a gap becomes a relief by compression of the rotary side seal lip member when the outward flange parts of the first slinger member and the second slinger members come into contact with each other when they are combined, thereby preferably keeping the sealing function of the incorporated part.

When the section of the second slinger member further provided with the outer cylindrical part is U-shaped and a part of the seal lip of the stationary side seal lip member elastically and slidably contacts with the inner diameter part of the outer cylindrical part, an actual elastically slidably contacting area of the stationary side seal lip member to the second slinger member becomes wide, thereby improving the sealing ability and, enlarging the design freedom of the stationary side seal lip.

In the present invention, when the rotary side sea lip member has an annular projecting part and the first slinger member and the second slinger member are fitted, the projecting part is compressed by the elastic deformation, so that the fitted part of the first slinger member and the second slinger member is sealed by the elastic surface pressure, thereby preventing entering of dirt to the fitted part and accomplishing a reliable rotation detection unit. Specifically when the gap is formed, the release at the time of compression accompanying the elastic deformation of the projecting part is secured by the gap and the sealing ability of the fitted part of the first slinger member and the second slinger member can be preferably kept.

Furthermore, when the first slinger member is made of a non-magnetic material, and the annular multipolar magnet is interposed between the outward flange part of the first slinger member and the outward flange part of the second slinger member, the annular multipolar magnet is protected by the first slinger member. When the bearing seal of the present invention is used for the bearing unit of automobile, it is exposed to severe environment in which it heavily hit by dust and dirt. However, the annular multipolar magnet is protected by the first slinger, thereby preventing damage on the magnet and keeping the function as the magnetic encoder for a long time. In addition, the first slinger member is made of a non-magnetic material, and when the rotation detection unit is constituted with the facing magnetic sensor, the detecting function of the magnetic change cannot be deteriorated.

### BRIEF DESCRIPTION OF DRAWINGS

FIG. 1 is a vertical sectional view of one embodiment of the bearing unit assembled with a bearing seal of the present invention.

FIG. 2 is an enlarged view of “X” part in FIG. 1.

FIG. 3 is a sectional view of a modified embodiment of the bearing seal.

FIG. 4 is a sectional view of other embodiment of the bearing seal like FIG. 2.

FIG. 5 is a sectional view of still other embodiment of the bearing seal like FIG. 3.

FIG. 6 is a sectional view of still other embodiment of the bearing seal like FIG. 3.

### DESCRIPTION OF EMBODIMENTS

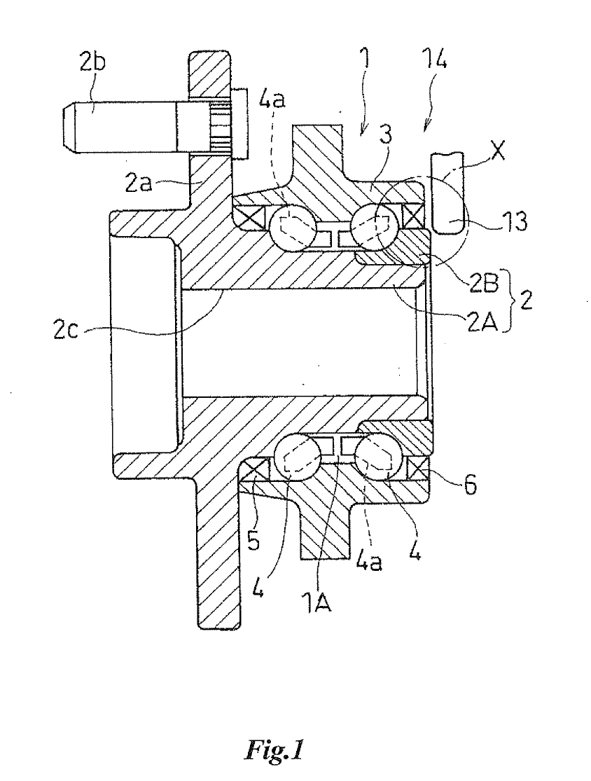

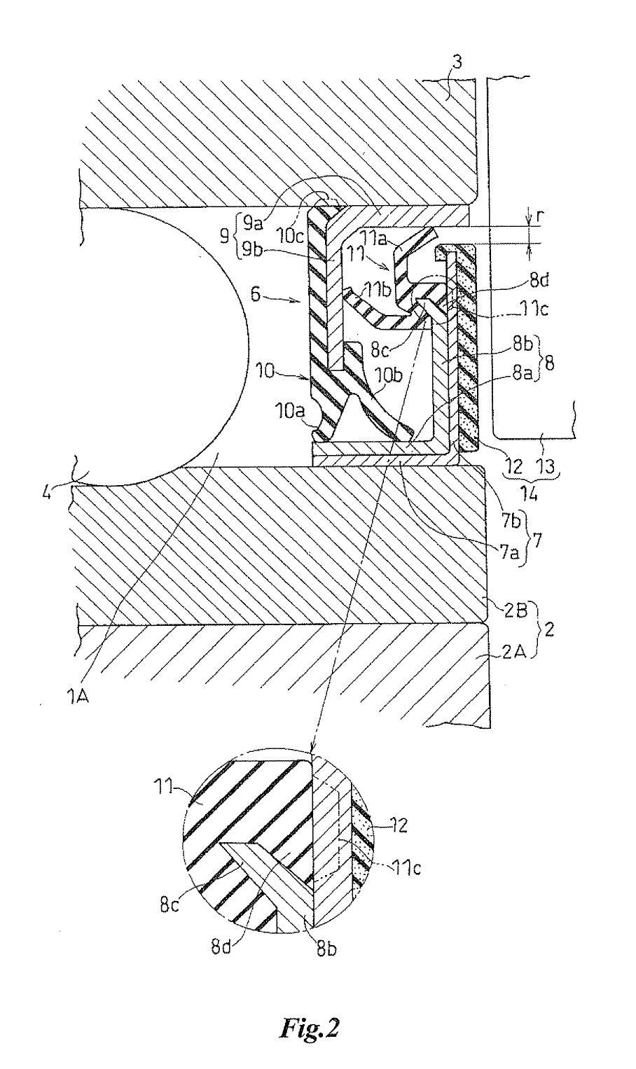

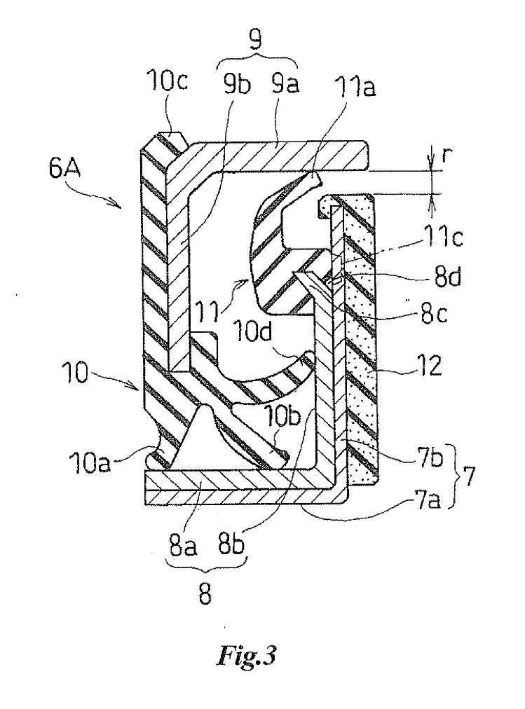

The best mode of the present invention is explained referring to drawings. FIG. 1 is a vertical sectional view of one embodiment of the bearing unit assembled with a bearing seal of the present invention, FIG. 2 is an enlarged view of “X” part in FIG. 1, and FIG. 3 to FIG. 6 are sectional views of an modified embodiment of the bearing seal.

FIG. 1 shows one example of a supporting structure of the automobile wheels with a rolling bearing unit 1. A tire wheel (not shown) is fixed to a hub flange 2a of a hub 2A constituting an inner ring (rotary side member) 2 with a bolt 2b. The drive shaft (not shown) is spline fitted in a spline shaft hole 2c formed in the hub 2A and the rotary drive force of the drive shaft is transmitted to the tire wheels. The hub 2A constitutes the inner ring 2 together with an inner ring member 2B. An outer ring (stationary side member) 3 is fixed to the automobile suspension (not shown) of the automobile body. Two rows of rolling elements (ball) 4 . . . are interposed between the outer ring 3 and the inner ring 2 while being held with a retainer 4a. The rolling elements 4 . . . and each orbit surface formed on the inner ring 2 and the outer ring 3 comprise a bearing part 1A and the inner ring 2 is rotatably supported relative to the outer ring 3 via the bearing part 1A. Outside of the axial direction of the orbit surface of the two rows of rolling elements (ball) 4 . . . , namely both sides of the axial direction of the bearing part 1A, seal rings (bearing seal) 5, 6 are mounted to be pressed and fitted between the outer ring 5 and the inner ring 2 in order to prevent leakage of lubricant (such as grease) filled in a rolling part (bearing space) of the rolling elements 4 . . . or to prevent muddy water and dirt from entering from the outside. A magnetic sensor 13 is provided for the outer ring 3 or the automobile body (stationary side member) so as to face the seal ring 6 on the automobile body side and the magnetic sensor 13 and an annular multipolar magnet (magnetic encoder) 12 mentioned later constitute a rotation detection unit 14 for detecting the rotary speed and rotary angle of the tire wheel. (see FIG. 2)

FIG. 2 shows an enlarged sectional view of the mounting part of the seal ring 6 on the automobile body side. The seal ring 6 comprises a first slinger member 7 having a circular part 7a integrally fitted to the outer circumference (outer diameter surface) of the inner ring member (rotary side member) 2B and an outward flange part (referred as a first slinger flange part, hereinafter) 7b extended from one end of the cylindrical part (referred as a first slinger cylindrical part hereinafter) 7a; a second slinger member 8 having a circular part 8a integrally fitted to the outer circumference (outer diameter surface) of the first slinger cylindrical part 7a and an outward flange part (referred as a second slinger flange part, hereinafter) 8b extended from one end of the cylindrical part (referred as a second slinger cylindrical part hereinafter) 8a; and a core member 9 having a circular part 9a integrally fitted to the inner circumference (inner diameter surface) of the outer ring (stationary side member) 3 and an inward flange part (referred as a core member flange part, hereinafter) 9b extended from one end of the cylindrical part (referred as a core member cylindrical part hereinafter) 9a. The core member 9 is fixed with a stationary side seal lip member 10 having seal lips 10a, 10b elastically and slidably contacting with the second slinger member 8. The second slinger member 8 is fixed with the rotary side seal lip member 11 having seal lips 11a, 11b elastically and slidably contacting with the core member 9. The annular multipolar magnet (magnetic encoder) 12 is provided on the automobile body side (magnetic sensor 13 side) of the first slinger flange part 7b. Accordingly, a bearing seal of pack seal type with a magnetic encoder is constructed.

The forming direction of the first slinger cylindrical part 7a and the second slinger cylindrical part 8a relative to the flange parts 7b, 8b, respectively, is same and the first and second slinger cylindrical parts are fitted and integrated in such a condition that the latter is fitted onto the former, and the first slinger cylindrical part 7a is fitted and integrated to the outer diameter surface of the inner ring member 2B under such conditions. The outer circumferential part of the second slinger flange part 8b is bent at 30 to 60 degrees in a direction of the second slinger cylindrical part 8a side to form a bent part 8c, in a direction apart from the outward flange part of the first slinger member, which forms a fixed base of the rotary side seal lip member 11. A gap 8d is formed by the bent part 8c between the outer circumferential part of the first slinger flange part 7b and the second slinger flange part 8b while the first slinger flange part 7b and the second slinger flange part 8b are engaged. The annular multipolar magnet 12 includes a magnet formed in annular and made of rubber or resin including magnetic powder or an annular sintered magnet in which a plurality of N poles and S poles are alternately provided at regular pitch along the circumferential direction. The figure shows a rubber magnet which is integrally attached with the first slinger member 7 at vulcanization molding so as to enter into the outer circumferential part on the automobile body side of the first slinger flange part 7b. The annular multipolar magnet 12 attached on the automobile body side of the first slinger flange part 7b closely faces the detecting surface of the magnetic sensor 13 provided on the stationary side, thereby constituting the rotation detection unit 14 for determining the rotation number and rotary angle of the wheels by detecting the magnetic change accompanied with rotation of the annular multipolar magnet 12.

The stationary side seal lip member 10 and the rotary side seal lip member 11 are made of an elastic material like rubber and have the seal lips 10a, 10b and seal lips 11a, 11b as mentioned above and are fixed and integrated with the core member 9 and the second slinger member 8. The stationary side seal lip member 10 is fixed so as to cover the inner circumferential part of the core member flange part 9b and to cover all the surface on the bearing unit part 1A side (opposite surface to automobile body). An annular projecting part 10c as a so-called nose part is formed at the outermost circumferential part, the projecting part 10c being elastically compressed when being fitted to the inner diameter surface of the outer ring 3 and sealing a space with the inner diameter surface of the outer ring 3 by the elastic surface pressure. The seal lips 10a, 10b are formed as a radial lip so as to elastically and slidably contact with the outer diameter surface of the second slinger cylindrical part 8a and have a function of preventing leakage of grease (not shown) filled in the bearing part 1A.

The rotary side seal lip member 11 is fixed so as to hold the bent part 8c formed at the outer circumferential part of the second slinger flange part 8b and to allow a part thereof to enter into the gap 8d and the annular projecting part (nose part) 11c is formed at a place which comes into contact with the first slinger flange part 7b. The annular projecting part 11c is formed such that it is elastically compressed and comes into contact under pressure with the first slinger flange part 7b by the elastic deformation when the first slinger member 7 and the second slinger member 8 are combined. The fitted part of the first slinger member 7 and the second slinger member 8 is sealed by the pressed contact accompanying such an elastic deformation, thereby preventing entering of dirt and mud in the fitted part. The outer circumferential part is bent at an angle of 30 to 60 degrees into the second slinger cylindrical part 8a as mentioned above, therefore, a relief (gap) 8d of the rubber material is secured between the bent part and the first slinger flange part 7b when the annular projecting part lib is elastically compressed, thereby smoothly executing the above elastic deformation. In addition, when the bent part 8c is designed to be fixed so as to hold the rotary side seal lip member 11, the fixing strength of the rotary side seal lip member 11 can be enhanced.

The seal lip 11a among the seal lips 11a, 11b constituting the rotary side seal lip member 11 is formed as a radial lip which elastically and slidably contacts with the inner diameter surface of the core member cylindrical part 9a and the seal lip lib is formed as an axial lip (side lip) which elastically and slidably contacts with the automobile body side of the core material flange part 9b. These seal lips 11a, lib prevent invasion of dirt and mud into the bearing seal 6 from a labyrinth “r” between the inner diameter surface of the core member cylindrical part 9a and the outer circumferential part of the annular multipolar magnet 12. In particular, the seal lips 11a, lib are rotated accompanied with rotation of the inner ring 2, so that the scattering function is exerted by the centrifugal force and the prevention effect of dirt can be more effectively achieved. Furthermore, the seal lip 11a is strongly pressed into the inner diameter surface of the core member cylindrical part 9a by the rotational centrifugal force, so that it can achieve better sealing function.

According to the structure of the bearing unit 1 as mentioned above, the wheels (not shown) and the inner ring 2 are supported rotatably relative to the outer ring 3 via the bearing part 1A. The first slinger member 7, the second slinger member 8 and the annular multipolar magnet 12 attached to the first slinger member 7 are axially rotated accompanied with rotation of the wheels and the inner ring 2. The magnetic change of N-pole and S-pole accompanied with rotation of the annular multipolar magnet 12 is detected by the magnetic sensor 13 and the rotation speed and rotary angle of the wheels are calculated based on the detected information.

The annular multipolar magnet 12 is integrally attached on the automobile body side of the first slinger flange part 7b of the first slinger member 7, and the entire surface on the automobile body side of the first slinger flange part 7b can be an attachment surface of the annular multipolar magnet 12. Therefore, the formed width of the annular multi-polar magnet 12 can be enlarged to adequately develop the magnetic force of the annular multipolar magnet 12. In particular, the outer diameter of the first slinger flange part 7b can be enlarged as far as possible if the labyrinth “r” is secured. Therefore, the attachment surface of the annular multipolar magnet 12 can be largely obtained without being limited by the rotary side seal lip member 11. When the magnetic sensor 13 is provided so as to face the annular multipolar magnet 12 and to constitute the rotation detecting unit 14, the annular multipolar magnet 12 as the magnetic encoder and the magnetic sensor 13 are easily positioned to each other and the design degree of the rotation detecting unit 14 is enhanced. In addition, when the outer diameter of the first slinger flange part 7b is made larger than that of the second slinger flange part 8b, the fixing part of the rotary side seal lip member 11 to the second slinger flange part 8b can be adequately obtained.

The bearing seal 6A in FIG. 3 is a modified embodiment of the bearing seal 6 in FIG. 2 and the structures of the stationary side seal lip member 10 and the rotary side seal lip member 11 are different. Namely, the stationary side seal lip member 10 has a seal lip 10d as an axial (side) lip elastically and slidably contacting with the surface on the bearing unit part 1A side of the second slinger flange part 8b in addition to the seal lips 10a, 10b as the radial lip as mentioned above. The rotary side seal lip member 11 does not have the seal lip lib as the above axial lip and has only the seal lip 11a as a radial lip. Such a difference between the seal lips of the seal lip members 10, 11 depends on the specification of the bearing unit 1, the size of the applied area (attachment space) and the like and can be selectively applied as a design matter.

Other structures and effects are same as those of FIG. 2 and the common parts have the same reference numbers and their explanations are omitted.

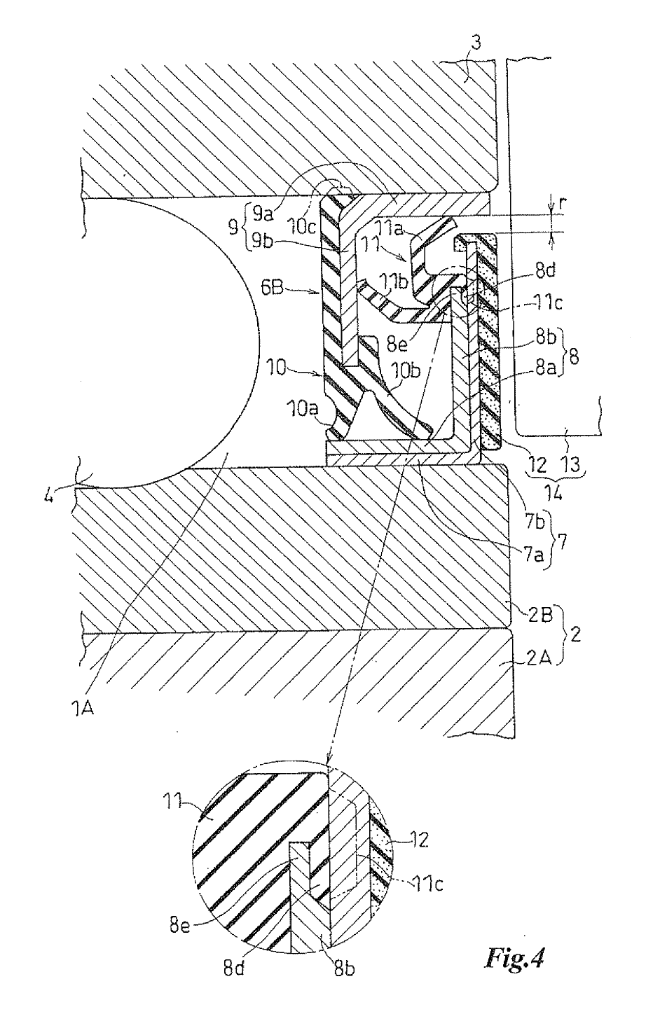

The bearing seal 6B in FIG. 4 is a modified embodiment of the bearing seal 6 of FIG. 2. According to the structure of the bearing seal 6B, the outer circumferential part of the second slinger flange part 8b is pressed into the second slinger cylindrical part 8a from the fitted part side (automobile body side) so as to form a thin part 8e, and the gap 8d is formed by the thin part 8e between the outer circumferential part of the first slinger flange part 7b and the second slinger flange part 8b wherein the first slinger flange part 7b and the second slinger flange part 8b are combined. The thin part 8e is formed as the fixing base of the rotary side seal lip member 11 as mentioned above and the rotary side seal lip 11 is fixed so as to hold the thin part 8e formed on the outer circumferential part of the second slinger flange part 8b and to allow the part thereof to enter the gap 8d. The annular projecting part (nose part) 11c is formed at a place which comes into contact with the first slinger flange part 7b as mentioned above.

Also in this case, the gap 8d functions as a relief of the rubber material when the annular projecting part 11c is elastically compressed and the first slinger 7b and the second slinger 8b are fitted and integrated. In addition, the fixing strength of the rotary side seal lip part 11 is also enhanced by fixing the rotary side seal lip member 11 so as to be held to the thin part 8e. The thin part 8e is formed such that the outer circumferential part of the second slinger flange part 8b is pressed into the second slit slinger cylindrical part 8a side from the fitted part side and the thin part 8e is formed liner in the centrifugal direction, thereby restraining excessive relief of the rubber material. Therefore, the sealing ability by the reaction force caused by the elastic compression of the annular projecting part 11c can be appropriately developed.

Whether the gap 8d is formed by the bent part 8c or by the thin part 8e depends on the shape of the annular projecting part 11c and the material of rubber and is appropriately adopted as a design matter. When the bent part 8c is formed by bending process, there are some concerns that the bending stress at the time of bending process is accumulated and bent deformation is caused by the reaction force of the sealing part. On the other hand, when it is formed with the thin part 8e, the relief allowability of the rubber material and maintenance of the sealing ability are easily balanced, thereby achieving design superiority.

Other structures and effects are same as those of FIG. 2 and the common parts have the same reference numbers and their explanations are omitted.

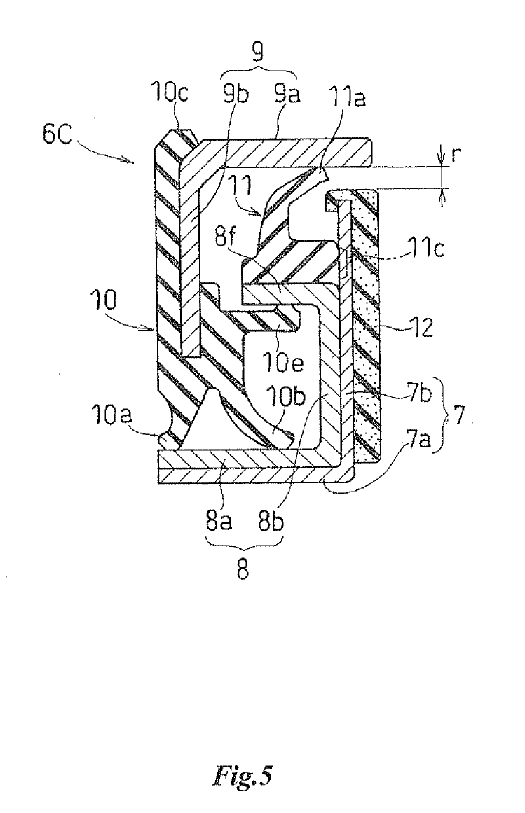

The bearing seal 60 in FIG. 5 is a further modified embodiment of the bearing seal 6 in FIG. 2. According to the structure of the bearing seal 60 in this embodiment, the second slinger member 8 is further provided with an outer cylindrical part 8f extended from the outer circumferential part of the second slinger flange part 8b and the section thereof is U-shaped. The stationary side seal lip member 10 has a seal lip (radial lip) 10e which elastically and slidably contacts with the inner diameter part of the outer cylindrical part 8f in addition to the seal lips (radial lip) 10a, 10b as mentioned above. The rotary side seal lip member 11 has the seal lip (radial lip) 11a which elastically and slidably contacts with the inner diameter part of the core member cylindrical part 9a. The outer cylindrical part 8f is thus connected to the second slinger member 8 and the actual slidably contacting area of the seal lips 10a, 10b, 10e of the stationary side seal lip member 10 can be widely secured, thereby enlarging free design ability of the seal lip.

It goes without saying that an axial lip elastically and slidably contacting with the second slinger flange part 8b is further provided. Other structures and effects are same as those of FIG. 2 and the common parts have the same reference numbers and their explanations are omitted.

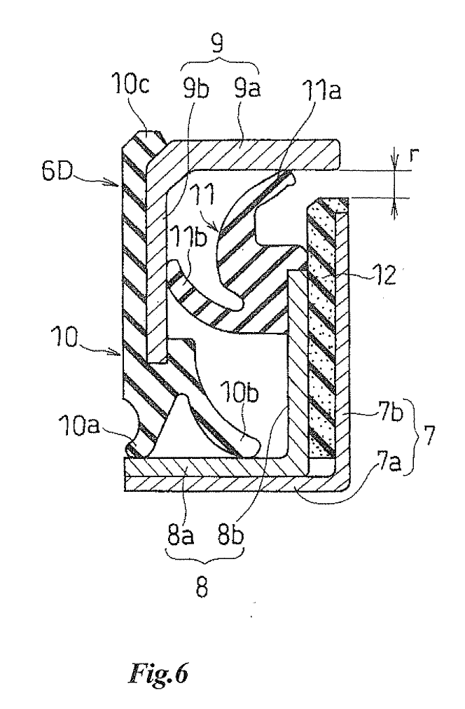

The bearing seal 6D in FIG. 6 is a modified embodiment of the bearing seal 6 of FIG. 2. According to the structure of the bearing seal 6D in this embodiment, the first slinger member 7 is made of a non-magnetic material, the annular multipolar magnet 12 is provided on the surface on the bearing part 1A side of the first slinger flange part 7b (the surface on the first slinger cylindrical part 7a side), and is designed to be interposed between the first slinger flange part 7b and the second slinger flange part 8b when the first slinger member 7 and the second slinger member 8a are fitted. Therefore, the magnetized surface of the annular multipolar magnet 12 is covered with the first slinger flange part 7b, thereby preventing from being hit by the dirt and dust and from being damaged. In particular, in case of the bearing unit of automobile, the bearing seal is exposed to severe environment, so that it is effective to detect the rotation at high accuracy. In addition, the first slinger member 7 having a protect function is made of a non-magnetic material, and the detection of magnetic change via the first slinger member 7 is not disturbed.

Meanwhile, according to the structure of the first slinger member 7 in each embodiment of FIG. 2 to FIG. 5, the annular multipolar magnet 12 is provided so as to be exposed on the automobile body side surface of the first slinger flange part 7b, so that the first slinger member 7 is not required to be a non-magnetic material. When it is rather made as a magnetic material, the flux density directing to the magnetic sensor 13 (see FIG. 2) from the magnetized surface can be enhanced, thereby being advantageous.

Other structures and effects are same as those of FIG. 2 and the common parts have the same reference numbers and their explanations are omitted.

In the above embodiments, the gap 8d is formed with the bent part 8c or the thin part 8e; however, it is not limited by them and can be constructed with other means. The embodiments are applied to the bearing unit supporting the automobile wheels, however, the bearing seal of the present invention can be used for the bearing unit which requires other rotational detection. In addition, the bearing unit 1 is comprised of the rotary side inner ring 2 and the stationary side outer ring 3 in the above embodiments, however, the present invention can be used when the inner ring side is directly formed on the rotary drive shaft.

### REFERENCE SIGNS LIST

1 bearing unit
2 inner ring (rotary side member)
3 outer ring (stationary side member)
6, 6A-6D bearing seal (seal ring)
7 first slinger member
7a first slinger cylindrical part
7b first slinger flange part (outward flange part)
8 second slinger member
8a second slinger cylindrical part
8b second slinger flange part (outward flange part)
8c bent part
8d gap
8e thin part
8f outer cylindrical part
9 core member
9a core member cylindrical part
9b core member flange part
10 rotary side seal lip member
10a, 10b, 10d, 10e seal lip
11 rotary side seal lip part
11a, 11b seal lip
12 annular multipolar magnet (magnetic encoder)

1. A bearing seal of pack seal type used for a bearing unit rotatably supporting a rotary side member on an inner ring side relative to a stationary side member on an outer ring side, said bearing seal comprising:
a first slinger member having a cylindrical part fitted onto said rotary side member and an outward flange part extended from one end of said cylindrical part of said first slinger member;
a second slinger member having a cylindrical part fitted onto said cylindrical part of said first slinger member and an outward flange part extended from one end of said cylindrical part of said second slinger member;
a core member having a cylindrical part fitted into said stationary side member and an inward flange part extended from one end of said cylindrical part of said core member;
a stationary side seal lip member fixed to said core member and having a seal lip contacting elastically and slidably with said second slinger member;
a rotary side seal lip member fixed to said second slinger member and having a seal lip contacting elastically and slidably with said core member; and
an annular multipolar magnet attached to said outward flange part of said first slinger member.

2. The bearing seal as set forth in claim 1, wherein:
said outward flange part of said second slinger member and said outward flange part of said first slinger member come into contact to each other when said first slinger member and said second slinger member are combined; whereby a gap is formed between an outer circumferential part of said outward flange part of said second slinger member and said outward flange part of said first slinger member; and wherein
said rotary side seal lip member is fixed to said outer circumferential part of said outward flange part of said second slinger member so as to hold said outer circumferential part.

3. The bearing seal as set forth in claim 2, wherein said outward flange part of said second slinger member has at its outer circumferential edge a bent part extending toward said cylindrical part of said second slinger member, by which said gap is constituted.

4. The bearing seal as set forth in claim 2, wherein said outward flange part of said second slinger member has its outer circumferential edge a pressed thin part, by which said gap is constituted.

5. The bearing seal as set forth in claim 1, wherein said second slinger member further has an outer cylindrical part extended from said outer circumferential part of said outward flange part so as to form a U-shaped section and a part of said seal lip of said stationary side seal lip member elastically and slidably contacts with an inner diameter part of said outer cylindrical part.

6. The bearing seal as set forth in claim 1, wherein said rotary side seal lip member has an annular projecting part elastically deformed by said outward flange part of said first slinger member and contacting under pressure when said first slinger member and said second slinger member are combined.

7. The bearing seal as set forth in claim 1, wherein said first slinger member is made of a non-magnetic material, and wherein said annular multipolar magnet is provided on a surface of said cylindrical part side of said outward flange part of said first slinger member and is further interposed between said outward flange part of said first slinger member and said outward flange part of said second slinger member when said first slinger member and said second slinger member are combined.

8. The bearing seal as set forth in claim 2, wherein said rotary side seal lip member has an annular projecting part elastically deformed by said outward flange part of said first slinger member and contacting under pressure when said first slinger member and said second slinger member are combined.

9. The bearing seal as set forth in claim 3, wherein said rotary side seal lip member has an annular projecting part elastically deformed by said outward flange part of said first slinger member and contacting under pressure when said first slinger member and said second slinger member are combined.

10. The bearing seal as set forth in claim 4, wherein said rotary side seal lip member has an annular projecting part elastically deformed by said outward flange part of said first slinger member and contacting under pressure when said first slinger member and said second slinger member are combined.

11. The bearing seal as set forth in claim 5, wherein said rotary side seal lip member has an annular projecting part elastically deformed by said outward flange part of said first slinger member and contacting under pressure when said first slinger member and said second slinger member are combined.
